(19) United States
(12) Patent Application Publication
(10) Pub. No.: US 2019/0366896 A1
(43) Pub. Date: Dec. 5, 2019

(54) SEAT HEADREST

(71) Applicant: Aysegul DURAK, Istanbul (TR)

(72) Inventor: Aysegul DURAK, Istanbul (TR)

(21) Appl. No.: 16/462,316

(22) PCT Filed: Dec. 14, 2017
(86) PCT No.: PCT/TR2017/050666

§ 371 Date: May 20, 2019

(30) Foreign Application Priority Data
Dec. 20, 2016 (TR) 2016/18987

(51) Int. Cl. B60N 2/806; A47C 7/38

(52) U.S. Cl. CPC B60N 2/806; B60N 2002/899; A47C 7/38

(57) ABSTRACT

A seat headrest is provided on a seat backrest for the purpose of supporting the head and neck without need for an orthopaedic pillow to improve comfort of vehicle seats during travel and having a bending mechanism that allows the seat headrest to be used in various shapes and positions by being bent.

### TECHNICAL FIELD

The invention relates to seat headrests provided on driver's, passenger's child/baby's seats in motor vehicles in order to support head and neck on the seat back while travelling.

The invention particularly relates to seat headrests on vehicle seats, improving comfort during travelling thanks to its unique shape, protecting head and neck orthopaedic without need for portable orthopaedic pillow, allowing placement as desired thanks to its height adjustability and take the shape given, and thus capable to meet passenger's needs change during travelling.

### BACKGROUND OF THE RELATED ART

In today's transportation, seats are one of the most important factors which affects travelling quality. One of the most important parts of the vehicle seats made in various ways because of the materials used in manufacturing, ergonomics etc. is seat headrests located above the seat backrest to support head and neck. Particularly during long distance travelling, one of the main issues that passengers suffer from is the neck stiffness and discomforts. It has been aimed to improve the comfort of the seats by use of various materials and ergonomics in seat headrests in order to prevent the problem.

One of the known application is the systems allowing height adjustment according to passenger's neck height as disclosed under the application numbered 1996/1055 and entitled “A Seat Headrest for Motor Vehicles”. In some applications side folding characteristic which allows passengers' head to partially lean to sideways is mentioned. However, none of the mentioned headrests provide a complete orthopaedic neck support.

In conclusion, existence of need for seat headrests on vehicle seats, improving comfort during travelling thanks to its unique shape, protecting head and neck orthopaedic without need for portable orthopaedic pillow, allowing placement as desired thanks to its height adjustability and manually changeable shape, and thus capable to adapt to various physiologies, and inadequacy of present solutions in the related art have made it necessary to make a development in the related art.

### PURPOSE OF THE INVENTION

The present invention relates to seat headrest meeting the needs mentioned above, eliminating all disadvantages and providing some additional advantages.

Main purpose of the invention is to disclose a seat headrest embodiment allowing manual height adjustment for neck height of the passengers having different heights, and also providing desired shape. Thus the seat headrest surrounds the neck fully and serves as orthopaedic neck pillow. As a result, neck stiffness and discomforts complained by passengers as mostly suffered from during long distance travelling can be prevented.

Another purpose of the invention is to provide a very comfortable sleeping possibility for the passenger allowing him/her to place his/her neck in the seat headrest when seat headrest is lifted up and made frame for the neck in position taking support from seat backrest. In such position in addition to resting the head it also promotes ergonomics and comfort of use.

A further purpose of the invention is to provide desired shape to a seat headrest therefore to obtain a seat headrest capable of providing the desirable comfort shape. Thus passenger's comfort can be provided by means of up, front, right and left adjusting seat headrest.

Another purpose of the invention is to provide a seat headrest adjusted according to user's height and sitting position by help of height adjustment mechanism providing height adjustment mechanism for the seat headrest and thus providing full support for neck even in flat position.

In order to achieve the above purposes in the most general way, seat headrests on vehicle seats, improving comfort during travelling thanks to its unique shape, protecting head and neck orthopaedic without need for an extra orthopaedic pillow, allowing placement as desired thanks to its height adjustability and taking any shape, and thus capable to adapt to various physiologies and changing needs are developed. In the developed form, the seat headrest comprises a seat headrest comprised of foam and interior mechanism grasping head and neck sections of the user, and a height adjustment mechanism allowing height adjustment by means of slide of the seat headrest.

In order to achieve the purposes of the invention, it is a seat headrest (4) provided on seat backrest (2) to support head and neck, and it is characterized in that the seat headrest (4) comprise a bending mechanism (4a) allowing use of seat headrest (4) in various ways and positions by help of its bending feature.

The structural and characteristics features of the invention and all advantages will be understood better in detailed descriptions with the figures given below and with reference to the figures, and therefore, the assessment should be made taking into account the figures and detailed explanations.

### BRIEF DESCRIPTION OF FIGURES

In order to make the embodiment and additional members being subject of the present invention as well as the advantages clearer for better understanding, it should be assessed with reference to the fallowing described figures.

FIG. 1 shows general view of seat headrest located on seats provided in vehicle and provided on seat backrests.

FIG. 2 shows general view of various positions of the seat headrest.

FIG. 2a shows view of seat headrest's use on seat backrest when in flat position.

FIG. 2b shows view of seat headrest's use in the position when seat headrest is in neck pillow on the seat backrest.

FIG. 2c shows view of seat headrest's use in the position when seat headrest is in head pillow on the seat backrest.

FIG. 2d shows view of seat headrest's use in the position when seat headrest supports head from side on the seat backrest.

FIG. 3 shows view of the seat headrest from various angles.

FIG. 3a is side view of the seat headrest.

FIG. 3b is top view of the seat headrest.

### REFERENCE NUMBERS

1. Seat
2. Seat Backrest
3. Height Adjustment Mechanism
4. Seat Headrest
   4a. Bending Mechanism
   4b. Interconnector
   4c. Height Adjustment Component
   4d. Protective Cover
   4e. Foam
   4f. Cover

### DETAILED DESCRIPTION OF THE INVENTION

In this detailed description, the preferred embodiments of the seat headrest (4) being subject of this invention have been disclosed solely for the purpose of better understanding of the subject and described in a manner not causing any restrictive effect.

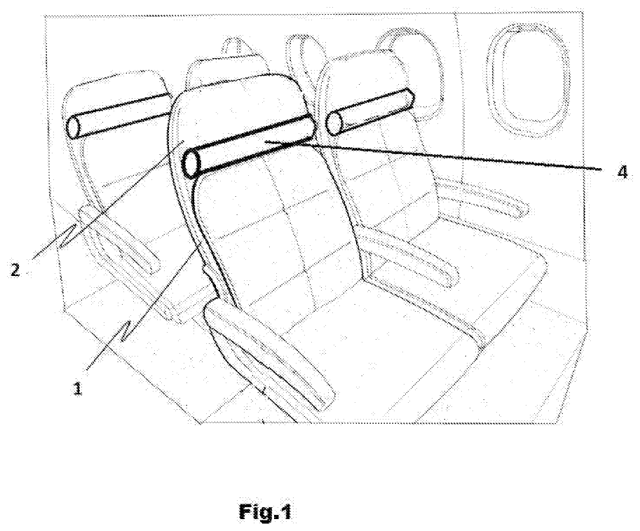

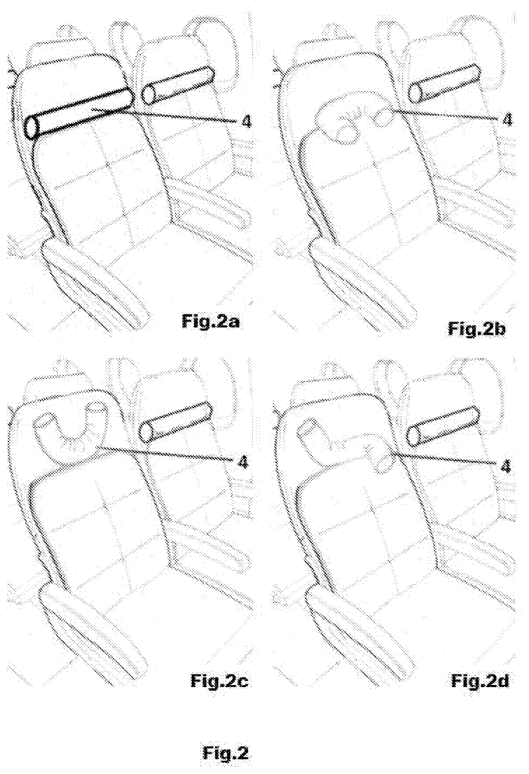

FIG. 1 shows general view of seat headrest (4) located on seats (1) provided in vehicle and provided on seat backrests (2). FIG. 2 shows views of seat headrest (4) in different positions according to different ways of use on the seat backrest (2). The embodiment of the seat headrest (4) preferably in cylinder form developed on the seat backrest (2) for the purpose placing to support head and neck comprises bending mechanism (4a) to provide the desired shaped to the seat headrest (4), height adjustment mechanism (3) for mounting the seat headrest (4) on the seat backrest (2) and used to move the seat headrest (4) up and down, interconnector (4b) used for connection of the seat headrest (4) and the height adjustment mechanism (3), and height adjustment component (4c) and protective cover (4d) covering the bending mechanism (4a). In addition, the seat headrest (4) is covered with foam (4e) and cover (4f).

While FIG. 2a shows view of use of seat headrest (4) in flat position on the seat backrest (2), FIG. 2b shows view of use in the position when seat headrest (4) is in neck pillow on the seat backrest (2), FIG. 2c shows view of use in the position when seat headrest (4) is used as head pillow on the seat backrest (2) and FIG. 2d shows view of seat headrest's (4) use in the position when seat headrest (4) supports head from side.

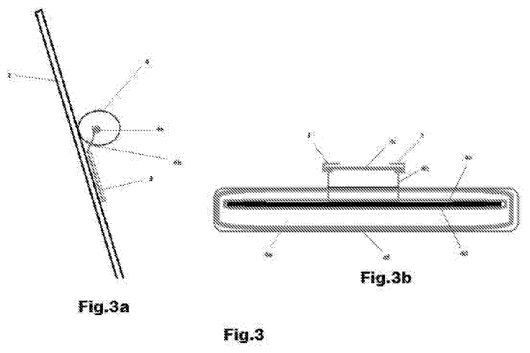

FIG. 3 shows view of the seat headrest (4) from various angles. Side view of the seat headrest (4) is given in FIG. 3a and top view is shown in FIG. 3b. The bending mechanism (4a) shown in FIG. 3b allows the seat headrest (4) to bend. With the bending, the seat headrest (4) can be used as neck pillow covering the neck fully, as head pillow in up position or as head support in side position. The bending mechanism (4a) is connected to the height adjustment mechanism (3) used to mount the seat headrest (4) to the seat backrest (2) by help of interconnector (4b) and height adjustment component (4c). The height adjustment component (4c) also provides sliding of the seat headrest (4) in the height adjustment mechanism (3). The height adjustment mechanism (3) providing vertical height adjustment allows height adjustment component (4c) motions of the seat headrest (4) in up and down direction. Thus the seat headrest (4) can be adjusted according to user's height and seating form to improve comfort.

1. A seat headrest provided on seat backrest to support head and neck, wherein the seat headrest comprises a bending mechanism allowing use of seat headrest in various ways and positions by help of its bending feature.

2. A seat headrest according to claim 1, wherein it is a seat headrest in cylindrical form.

3. A seat headrest according to claim 1, wherein it comprises a height adjustment mechanism providing installation of the seat headrest on the seat backrest and allowing height adjustment of the seat headrest.

4. A seat headrest according to claim 1, wherein it comprises a height adjustment component fitted into the height adjustment mechanism located on the seat backrest.

5. A seat headrest according to claim 1, wherein it comprises an interconnector located between the bending mechanism inside the seat headrest and the height adjustment mechanism and providing their connection.
